(19) United States
(12) Patent Application Publication
(10) Pub. No.: US 2005/0198675 A1
(43) Pub. Date: Sep. 8, 2005

(54) Entertainment system to be mounted to a child's high chair

(76) Inventors: Jeffrey Stuart Hunt, Concord, MA (US); Matthew Nuffort, Lexington, MA (US)

Correspondence Address: Jeffrey Hunt, 58 FARMERS CLIFF RD, CONCORD, MA, 01742, US

(21) Appl. No.: 11/061,160

(22) Filed: Feb. 18, 2005

Related U.S. Application Data
(60) Provisional application No. 60/545,566, filed on Feb. 18, 2004.

(51) Int. Cl. H04N 11/00; H04N 7/00; H04N 7/18

(52) U.S. Cl. 725/80; 725/74; 348/552

(57) ABSTRACT

An interconnected audio and video entertainment system to be mounted to a child's seat such as a high chair. It includes one or more video and audio sources, a video screen positioned at the preferred viewing orientation, and speakers that are positioned to maximize audibility for the chair's occupant and to minimize audibility from outside the chair. The innovative audio arrangement makes the system appropriate for use in environments where it is desirable to reduce ambient noise from the device, including but not limited to public places such as restaurants.

### RELATED APPLICATIONS

The present application is a continuation-in-part application of U.S. provisional patent application Ser. No. 60/545,566, filed Feb. 18, 2004, for QUIET ENTERTAINMENT SYSTEM FOR CHILD'S SEAT, by Jeffrey Stuart Hunt, Matthew Nuffort, included by reference herein and for which benefit of the priority date is hereby claimed.

### FIELD OF THE INVENTION

The present invention relates to an entertainment system to be attached to a child's high chair, and, more particularly, to an enclosed audio and video system adapted for interconnection to a child's seat to entertain the child when seated therein such that the picture is seen and the audio is heard by the user but such that sound is emitted from the unit at a low level.

### BACKGROUND OF THE INVENTION

It is well-known that most young children will become restless or agitated if they are forced to sit in a seat for more than a few minutes, making it difficult for parents to bring their children to public places, particularly restaurants, where they will need to be seated for an extended period of time.

In the past, several attempts have been made to address this problem, including by entertaining a child with audio and video when seated in a car seat or stroller in an effort to occupy the child's attention. An example of such a solution is found in the U.S. patent to Leal, et al., U.S. Pat. No. 5,624,156. Takada also discloses an entertainment system for a child safety seat in U.S. Pat. No. 4,949,777.

While the various proposed solutions in the prior art are effective to capture a child's attention when seated in a car seat or like device, they have several shortcomings, which limit their commercial feasibility. In particular, the child safety seats disclosed in prior patents are appropriate for private use and other environments in which it is not important to limit the audibility of the entertainment to the chair's occupants, but they are not appropriate for environments where sound that escapes the unit must be minimized. They also are not appropriate for use in dining situations, because the inventions do not contemplate the specific requirement for this environment, namely, a dining surface that is part of the unit and protection against exposure to food and liquids. More particularly, they are not appropriate for use within a restaurant environment because they can not be efficiently stored and recharged.

It is therefore an object of the invention to provide an entertainment system for children.

It is another object of the invention to entertain a child with a system, which includes one or more speakers and one or more video screens, which interconnect to an audio and video source that can be used to provide a child with audio and video entertainment.

It is another object of the invention to provide this entertainment to a child seated in a chair designed specifically for children, including but not limited to high chairs.

It is another object of the invention to include an adjustable speaker system that is configured to make the entertainment audible to the occupant of the chair but to minimize the noise it produces outside the unit, so the invention can be used in a public place such as a restaurant or barber shop as well as in a home environment.

It is another object of the invention to attach securely to existing seats designed for children, such as a standard wooden restaurant high chair.

It is another object of this invention to protect the electronic components from elements encountered in a restaurant such as exposure to liquid and impact.

It is another object of the invention to be easily transported by waitstaff in a restaurant.

### SUMMARY OF THE INVENTION

In accordance with the present invention, there is provided an entertainment system specifically designed for a child seat, such as a high chair, and which includes a video screen that is visible to the child in the seat and an adjustable speaker system that is audible to a child in the seat but that minimizes sound that escapes from the seat. This system can be attached to a seat that is traditionally used for a child, such as a high chair.

The components of the system are powered by an electric power source such as rechargeable batteries within the system or an external power source such as a DC power source or a battery.

### BRIEF DESCRIPTION OF THE DRAWINGS

A complete understanding of the present invention may be obtained by reference to the accompanying drawings, when considered in conjunction with the subsequent, detailed description, in which:

FIG. 1 is a perspective view of a complete entertainment system attached to a high chair. The unit slides down on top of the high chair and is fastened in place with a strap;

FIG. 2 is a perspective view of an entire assembly with tray and speakers attached;

FIG. 3 is a perspective view of an unit with the tray removed to display easy access to the protected area that houses the electronic components;

FIG. 4 is a perspective view of an unit stacked on top of another unit. The shells are hollow inside, allowing a unit to be stacked;

FIG. 5 is a perspective bottom view of an underside of the entertainment unit; and

FIG. 6 is a perspective view of an an embodiment of the speaker adjustment system demonstrating one mechanism for achieving optimal positioning of the speakers relative to the chair's occupant.

For purposes of clarity and brevity, like elements and components will bear the same designations and numbering throughout the FIGURES.

### DESCRIPTION OF THE PREFERRED EMBODIMENT

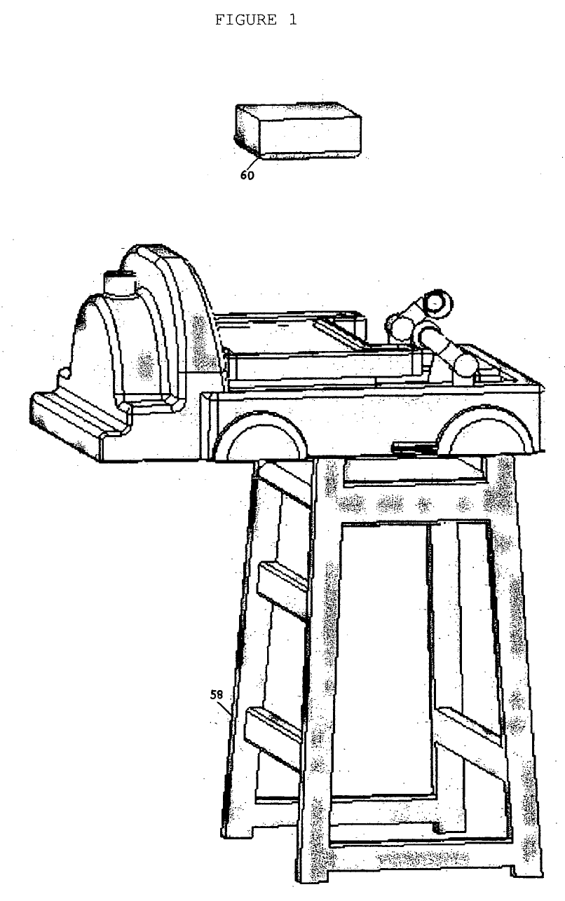

FIG. 1 is a perspective view of a complete entertainment system mounted to a high chair 58. In this embodiment, the unit slides down on top of and fits snugly to a common wooden high chair 58. While the unit is designed to attach snugly to a standard restaurant high chair 58 without a restraining strap, a mounting mechanism 32 is molded as part of the shell 56 as a safety mechanism. The strap will pass underneath the seat of the high chair 58 and attach to the mounting mechanism 32 on the other side of the shell 56. In the embodiment, the shell 56 is shaped like a train to demonstrate that it is designed to appeal to children. The shell 56 could similarly take the form of an airplane, race car, space ship, animal, or any other form that appeals to young children.

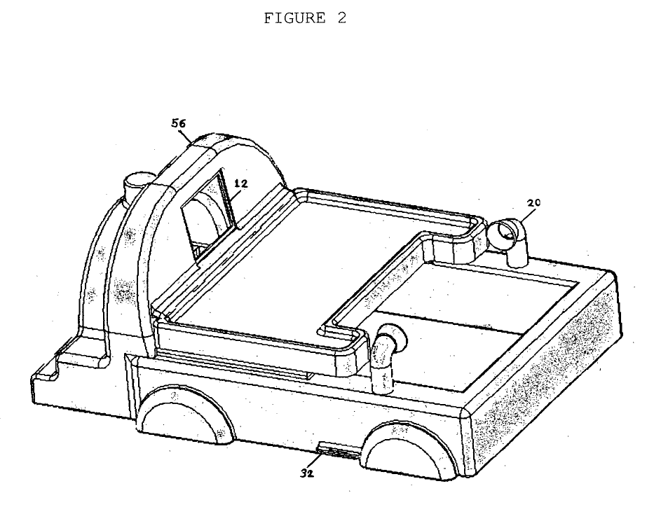

FIG. 2 is a perspective view of the entire assembly with tray and speakers attached. It includes a video screen 12 that is mounted to the shell 56 and positioned so an occupant of the high chair 58 with the unit attached will be positioned for viewing the video entertainment. It also includes a speaker system 20 with a speaker adjusting mechanism utilizing an elbow-type joint that enables the speakers to be flexibly positioned to align them with the occupant's ears. The speaker system 20 also includes a sound focusing mechanism, similar to a mega phone, that directs the sound waves toward the occupant of the high chair 58. This embodiment shows a removable food tray 48 that enables the chair's occupant to use the entertainment system for dining, while at the same time protecting the electronic components inside the shell 56. It also includes a protective shell 56 to house the components. In this embodiment the speaker system 20 is extended to its maximum height, with the elbow joint straight and component below the elbow fully extended.

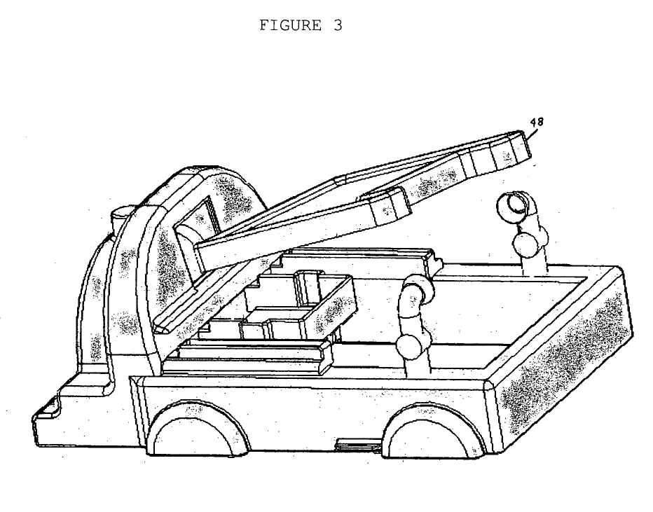

FIG. 3 is a perspective view of a unit with the tray removed to display an easy method of accessing entertainment player in the protected area that houses the electronic components. In this embodiment, the tray snaps into place by fitting snugly to the molded shell 56. The tray fits underneath a lip molded to the shell 56 that ensures any liquid or food spilled on the unit will end up on the tray and not in the electronic components. The tray is designed to attach to rails on the shell 56 with a mechanism that locks it in place such that the child seated in the chair cannot remove the tray. While this embodiment shows a removeable food tray 48, the entertainment unit could also have a permanently attached food tray 48 or other flat surface that can be used for dining. Further, it could not have a food tray 48 at all.

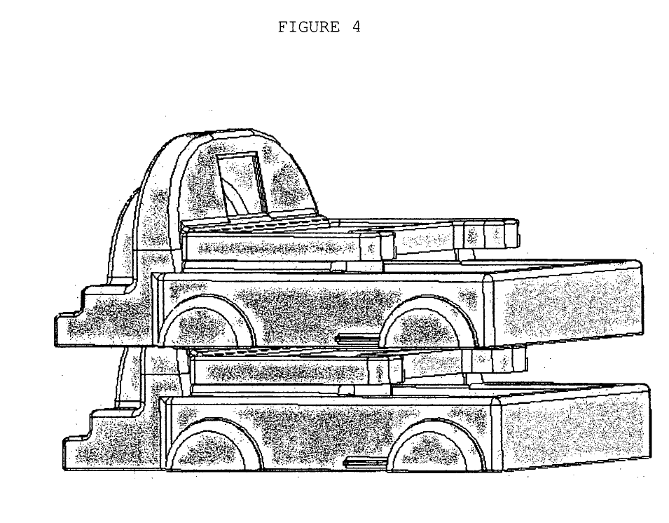

FIG. 4 is a perspective view of the units stacked on top of each other. The unit is formed such that the convex top fits into the concave bottom, allowing a unit to be stacked on top of another unit into a stacking configuration. In this embodiment, speakers telescope down into the shell 56 to facilitate stacking. They can also be positioned forward or backward around the elbow to facilitate stacking and to avoid damage to the speaker assembly.

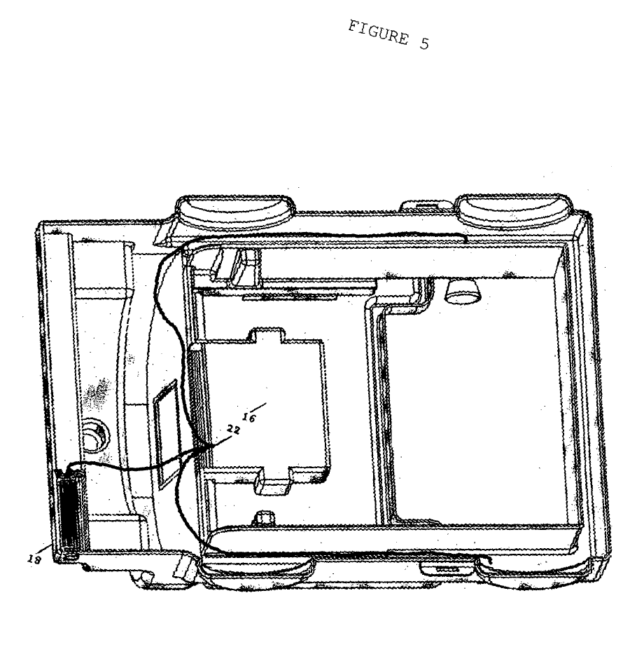

FIG. 5 is a bottom perspective view of the underside of the entertainment unit. It demonstrates the location of the audio and video source 16, demonstrating how it interconnects through the wiring system 22 with the video screen 12, the speaker system 20, and the power source 18. The power source 18 may be rechargeable. The audio and video source 16 may also be a unit that receives an external signal from a wireless network module 60 shown in FIG. 1. The power supply is attached to the shell 56 at an opening at the front of the shell 56. This opening is designed to enable a power cord to be connected to the power supply for recharging the internal batteries in the unit. The underside of the shell 56 is designed in such a way to enable the child's legs to be unimpeded while seated in the chair.

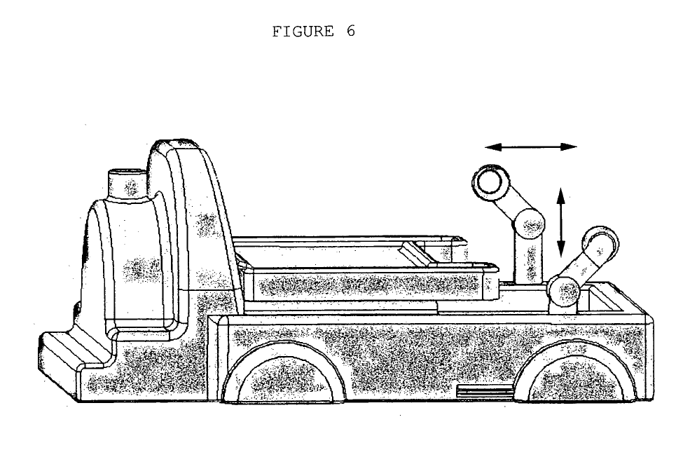

FIG. 6 is a perspective view of an embodiment of the speaker system 20 that demonstrates one mechanism for achieving optimal positioning of the speakers relative to the chair's occupant. In this embodiment, each speaker is housed in a two-piece rigid cylinder. One piece is inserted into a corresponding hole in the shell 56 such that it can be moved up and down to adjust the speaker height. The second piece is attached to the first through an elbow joint, such that it can rotate to position the speakers fore and aft. Together these two adjustment mechanisms make it possible to align the speakers directly with the occupant's ears. In addition, this embodiment demonstrates the speaker system 20 with a conical mechanism for focusing the sound that is emitted from the speaker system 20. The described attributes of the speaker system 20 ensure maximal audibility within the unit at the lowest possible total volume, minimizing audibility outside the unit.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Having thus described the invention, what is desired to be protected by Letters Patent is presented in the subsequently appended claims.

1. An entertainment system to be mounted to a child's high chair for providing audio and video entertainment that can be enjoyed in a public environment comprising:
means for displaying the visual portion of the entertainment;
means for housing components and protecting entire unit and providing ornamental qualities, removably fastened to said means for displaying the visual portion of the entertainment;
means for mounting and securing entertainment unit to high chair, rigidly connected to said means for housing components and protecting entire unit and providing ornamental qualities;
means for delivering audio portion of entertainment;
means for providing an audio and video content feed to the screen and speaker system, electrically connected to said means for delivering audio portion of entertainment, removably attached to said means for housing components and protecting entire unit and providing ornamental qualities, and electrically connected to said means for displaying the visual portion of the entertainment;
means for providing electrical power to enable entertainment system to operate, electrically connected to said means for providing an audio and video content feed to the screen and speaker system, and removably attached to said means for housing components and protecting entire unit and providing ornamental qualities; and
means for interconnecting power source with the content source, video screen and speakers, electrically connected to said means for providing electrical power to enable entertainment system to operate, electrically connected to said means for providing an audio and video content feed to the screen and speaker system, electrically connected to said means for delivering audio portion of entertainment, removably attached to said means for housing components and protecting entire unit and providing ornamental qualities, and electrically connected to said means for displaying the visual portion of the entertainment.

2. The entertainment system to be mounted to a child's high chair in accordance with claim 1, wherein said means for displaying the visual portion of the entertainment comprises a video screen.

3. The entertainment system to be mounted to a child's high chair in accordance with claim 1, wherein said means for housing components and protecting entire unit and providing ornamental qualities comprises a shell.

4. The entertainment system to be mounted to a child's high chair in accordance with claim 1, wherein said means for mounting and securing entertainment unit to high chair comprises a mounting mechanism.

5. The entertainment system to be mounted to a child's high chair in accordance with claim 1, wherein said means for delivering audio portion of entertainment comprises a speaker system.

6. The entertainment system to be mounted to a child's high chair in accordance with claim 1, wherein said means for providing an audio and video content feed to the screen and speaker system comprises an audio and video source.

7. The entertainment system to be mounted to a child's high chair in accordance with claim 1, wherein said means for providing electrical power to enable entertainment system to operate comprises a power source.

8. The entertainment system to be mounted to a child's high chair in accordance with claim 1, wherein said means for interconnecting power source with the content source, video screen and speakers comprises a wiring system.

9. An entertainment system to be mounted to a child's high chair for providing audio and video entertainment that can be enjoyed in a public environment comprising:
a video screen, for displaying the visual portion of the entertainment;
a shell, for housing components and protecting entire unit and providing ornamental qualities, removably fastened to said video screen;
a mounting mechanism, for mounting and securing entertainment unit to high chair, rigidly connected to said shell;
a speaker system, for delivering audio portion of entertainment;
an audio and video source, for providing an audio and video content feed to the screen and speaker system, electrically connected to said speaker system, removably attached to said shell, and electrically connected to said video screen;
a power source, for providing electrical power to enable entertainment system to operate, electrically connected to said audio and video source, and removably attached to said shell; and
a wiring system, for interconnecting power source with the content source, video screen and speakers, electrically connected to said power source, electrically connected to said audio and video source, electrically connected to said speaker system, removably attached to said shell, and electrically connected to said video screen.

10. The entertainment system to be mounted to a child's high chair as recited in claim 9, further comprising:
a food tray, for providing occupant with a surface for dining, removably connected to said shell.

11. The entertainment system to be mounted to a child's high chair as recited in claim 9, further comprising:
a wireless network module, for connecting individual entertainment units to a central content source.

12. The entertainment system to be mounted to a child's high chair as recited in claim 10, further comprising:
a wireless network module, for connecting individual entertainment units to a central content source.

13. The entertainment system to be mounted to a child's high chair as recited in claim 9, wherein said speaker system has characteristics selected from the following group: means for adjusting position, and means for focusing sound.

14. The entertainment system to be mounted to a child's high chair as recited in claim 10, wherein said speaker system has characteristics selected from the following group: means for adjusting position, and means for focusing sound.

15. The entertainment system to be mounted to a child's high chair as recited in claim 11, wherein said speaker system has characteristics selected from the following group: means for adjusting position, and means for focusing sound.

16. The entertainment system to be mounted to a child's high chair as recited in claim 12, wherein said speaker system has characteristics selected from the following group: means for adjusting position, and means for focusing sound.

17. An entertainment system to be mounted to a child's high chair for providing audio and video entertainment that can be enjoyed in a public environment comprising:
a video screen, for displaying the visual portion of the entertainment;
a shell, for housing components and protecting entire unit and providing ornamental qualities, removably fastened to said video screen;
a mounting mechanism, for mounting and securing entertainment unit to high chair, rigidly connected to said shell;
a means for adjusting position, means for focusing sound speaker system, for delivering audio portion of entertainment;
an audio and video source, for providing an audio and video content feed to the screen and speaker system, electrically connected to said speaker system, removably attached to said shell, and electrically connected to said video screen;
a power source, for providing electrical power to enable entertainment system to operate, electrically connected to said audio and video source, and removably attached to said shell;
a wiring system, for interconnecting power source with the content source, video screen and speakers, electrically connected to said power source, electrically connected to said audio and video source, electrically connected to said speaker system, removably attached to said shell, and electrically connected to said video screen;
a food tray, for providing occupant with a surface for dining, removably connected to said shell; and
a wireless network module, for connecting individual entertainment units to a central content source.
